(19) United States
(12) Patent Application Publication
(10) Pub. No.: US 2024/0169316 A1
(43) Pub. Date: May 23, 2024

(54) CONTENT CREATION AND PUBLISHING METHOD

(71) Applicant: Robin Andrew Kirton, Naniamo (CA)

(72) Inventor: Robin Andrew Kirton, Naniamo (CA)

(21) Appl. No.: 18/057,775

(22) Filed: Nov. 22, 2022

(51) Int. Cl. G06Q 10/101; G06F 40/103; G06F 40/166; G06Q 50/18

(52) U.S. Cl. CPC G06Q 10/101; G06F 40/103; G06F 40/166; G06Q 50/184; G06Q 50/01

(57) ABSTRACT

A content creation and publishing method that is employed for development of a book wherein the method of the present invention provides collaboration between a co-author and another entity that facilitates creation and publication of a book. The operator of the present invention enrolls individuals wherein the individuals engage in a royalty agreement with the operator. The present invention facilitates collection of an experience or story from the individual and transforms the information into a book. The present invention utilizes an artificial intelligence-based software to execute word volume expansion of the content provided by the operator. A ghost writer is employed to provide final drafting of the content and an editor is additionally involved to provide editing, typesetting and additional tasks. A royalty agreement is executed between the individual and the operator wherein the royalty agreement details financial terms and conditions.

### FIELD OF INVENTION

The present invention relates generally to entertainment product development, more specifically but not by way of limitation, a method operable to facilitate content collaboration and product development wherein the product development is provided in a form of written and audio books.

### BACKGROUND

Millions of people read on a regular basis for both enjoyment and for education purposes. Books are available in various forms that include but are not limited to audio, hard copy and electronic. Regardless of the type of book that is provided there are two major components that go into the development and creation of the book. A first component for book formation is content creation. For content creation, an author must be able to develop a story wherein the story can be in any category. Content creation can be executed either solely or as a collaborative effort between more than one individual. Ensuing content creation, the creators must be able to facilitate the book being published. Publishing a book and distribution thereof can provide many obstacles that can include but are not limited to executing a deal with a publisher and obtaining a viable distribution channel having the ability to ensure successful commercialization of the book.

While there is no shortage of content creators and book publishers, one segment of the population is typically absent from the demographic of content creators. Senior citizens, those over sixty-five, currently represent the largest section of the population in North America. Many of these individuals have had life experiences that if properly captured would be able to be developed into successful content for a book being in any one of numerous categories. An issue exists with an ability to capture the ideas and experiences of seniors wherein the majority of that demographic doesn't understand or have experience with book creation or publishing. An ability to facilitate a collaborative process with this demographic would lead to not only the aforementioned demographic having some commercial success but an ability to share their life experiences as stories that can be distributed to other generations.

It is intended within the scope of the present invention to provide a content creation and publishing method wherein the present invention provides a collaborative process that enables content creation for books and further facilitates the publishing and distribution thereof.

### SUMMARY OF THE INVENTION

It is the object of the present invention to provide a method for collaborative content creation and subsequent publication of the content wherein the present invention includes alternate levels of investment.

Another object of the present invention is to provide a publishing method for content that has been created through a mutual development process wherein the alternate levels of investment have different royalty structures associated therewith.

A further object of the present invention is to provide a method for collaborative content creation and subsequent publication of the content wherein the present invention provides conversion of informal content such as notes or audio recordings into a cohesive story for a book.

Still another object of the present invention is to provide a publishing method for content that has been created through a mutual development process wherein the present invention further includes a step including proof reading and text formatting.

An additional object of the present invention is to provide a method for collaborative content creation and subsequent publication of the content wherein the present invention further includes a step for title and cover development.

Yet a further object of the present invention is to provide a publishing method for content that has been created through a mutual development process wherein the content creation can be in any category.

Another object of the present invention is to provide a method for collaborative content creation and subsequent publication of the content wherein the present invention further includes a step for promotion and advertisement management.

An alternate object of the present invention is to provide a publishing method for content that has been created through a mutual development process wherein the content creation can be either fiction or non-fiction.

Still a further object of the present invention is to provide a method for collaborative content creation and subsequent publication of the content wherein the present invention further includes the step of hosting seminars for potential content creators.

An additional object of the present invention is to provide a publishing method for content that has been created through a mutual development process wherein the present invention further includes providing of a website wherein the website includes but is not limited to an itemized catalog of all developed content.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an outline of the method of the present invention from an operator perspective; and

FIG. 2 is an outline of the process of the present invention from a co-author perspective.

### DETAILED DESCRIPTION

Referring now to the drawings submitted herewith, wherein various elements depicted therein are not necessarily drawn to scale and wherein through the views and figures like elements are referenced with identical reference numerals, there is illustrated a content creation and publishing method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the process of the content creation and publishing method 100 is outlined therein. It should be understood within the scope of the present invention that the steps discussed herein of the content creation and publishing method 100 could be executed in alternate orders or further have some thereof omitted and still successfully execute the scope of the present invention.

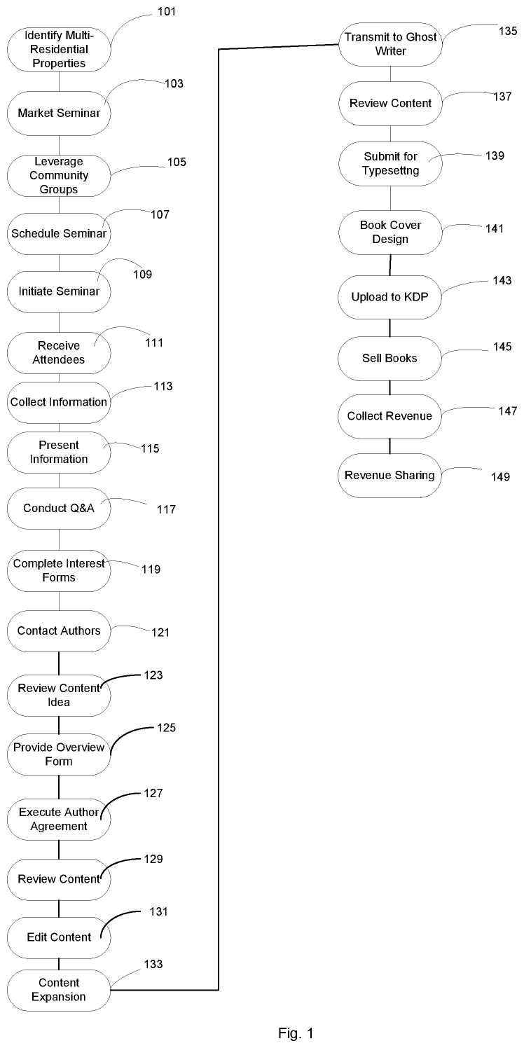

Referring now to FIG. 1 submitted herewith, the content creation and publishing method 100 commences from an operator thereof with step 101 wherein in step 101 the operator identifies at least one multi-residential property. It is desired within the scope of the present invention that multi-residential properties having an age demographic of fifty-five and over are targeted in an attempt to identify prospective co-authors. While this is a preferred demographic, it should be understood within the scope of the present invention that alternate types of properties and/or demographics could be targeted to identify potential co-authors. In step 103, the operator will market an educational seminar at the multi-residential property in order to drive awareness of the seminar to the residents of the property. It should be understood within the scope of the present invention that the marketing could include but is not limited to the posting of flyers within the property. Step 105, the operator of the content creation and publishing method 100 will further leverage community groups and similar organizations with ties to the residents of the targeted property in an effort to further drive awareness about the educational seminar that is configured to provide information about the content creation and publishing method 100. It is further contemplated within the scope of the present invention that the operator could employ utilization of a website or other types of electronic media in order to drive awareness of the education seminar reviewing the content creation and publishing method 100.

Step 107, the operator will schedule the date and time for the seminar wherein any marketing thereof will include this data. In step 109, the operator will initiate the seminar. Step 111, the operator will receive attendees at the seminar location. In step 113, as the attendees are received at the seminar, the operator will collect information from the attendees. This information can include but is not limited to name, age and contact information. Step 115, the operator will present the attendees at the seminar information about the content creation and publishing method 100. It should be understood within the scope of the present invention that conventional presentation software and speaking will be utilized to present the information to the attendees. During the presentation of the content creation and publishing method 100 there will be a plurality of information presented to the attendees. It should be understood within the scope of the present invention that the presentation could include but is not limited to explanation of the publishing company, explanation of the mission of the content creation and publishing method 100, explanation of the brand name, details about the publishing process, explanation of the process for becoming a co-author and discussion of the royalty agreement and the levels thereof.

In step 117, the operator will conduct a question and answer session wherein the operator will entertain questions from the attendees of the seminar. Step 119, for attendees that are interested in becoming a co-author, the operator will provide the interested attendees an interest form wherein the interest form is completed by the attendee. It should be understood within the scope of the present invention that the interest form is operable to collect the necessary raw data for subsequent content creation wherein the content creation is produced into a published book. In step 121, the operator or agents thereof will contact any attendee that accepted the interest form to discuss completion thereof and advancement of the content creation and publishing method 100 so as to create a published book. Step 123, the operator and the potential co-author conduct at least one meeting to review the information disclosed in the interest form wherein the operator and potential co-author review and discuss the merit of the disclosure so as to assess the probability of converting the content disclosure into a book. In step 125, the interest form is fully completed by the potential co-author. Step 127, the operator and potential co-author execute a royalty agreement, discussed further herein, wherein the potential co-author has agreed to become a co-author of a book for financial terms agreed to in the royalty agreement.

In step 129, the co-author provides the final content disclosure to the operator wherein the content will be converted into a book by the operator. Step 131, the operator will provide initial edit of the content. In step 133, n the initial edit of the content, the operator will employ an artificial intelligence based software that will provide a word volume expansion of the provided content so as to expand the content to a suitable word volume for creation of a book. The word volume expansion is desired as the content received from the co-author is similar to that of a high level summary and as such material development and expansion thereof is required in order to produce a book of appropriate content and length. It is contemplated within the scope of the present invention that the word volume expansion executed by the software would be within the range of fifty to eighty percent. Step 135, the operator will transfer the expanded content to a ghost writer. The ghost writer will focus attention on editing the content so as to transform the content to increase the factuality and/or authoritative perspective thereof. It is further contemplated within the scope of the present invention that the ghost writer could make various other edits and/or embellishment/wordsmithing of the content. In step 137, the ghost writer transmits the revised content back to the operator wherein the operator will review the revised content. If deemed necessary by the operator, subsequent rounds of transmission between the operator and ghost writer could occur until the operator has accepted the content provided by the ghost writer. In step 139, the final approved version of the content is submitted for typesetting to complete the final formatting so as to be ready to publish into a book. Step 141, the operator will initiate and finalize a book cover design to be utilized for the printed book. In step 143, the upload the formatted content to an on-demand publishing platform, such as but not limited to Amazon KDP. Within step 143 execution of marketing decisions are made that will be conducted in an effort to market the book. By way of example but not limitation decisions/activities can include but are not limited to: time limited discounted sales, reviewer codes, advertisements, search engine optimization and social media campaigns. Step 145, the operator will initiate the sales of books through various channels such as but not limited to on-line channels. In step 147, the operator will collect revenue for the sale of the book created by the operator and the co-author. Step 149, the operator will share a portion of the revenue with the co-author in accordance with the terms of the royalty agreement, discussed further herein.

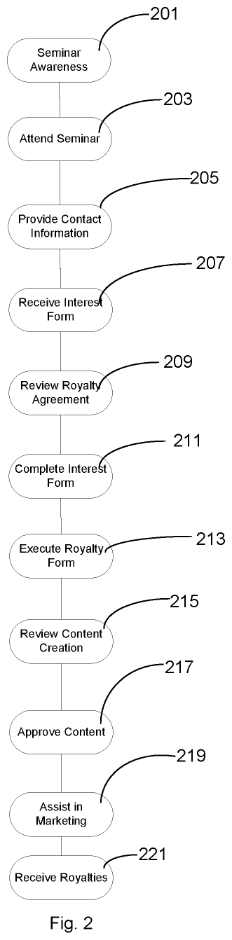

Now referring to FIG. 2 submitted herewith, an overview of the portion of the present invention from the co-author perspective is outlined therein. In step 201, a potential co-author is made aware of an informational seminar providing education on the content creation and publishing method 100. Step 203, the potential co-author will attend the educational seminar about the content creation and publishing method 100. In step 205, the potential co-author will provide contact information to the operator of the content creation and publishing method 100 at the educational seminar. Step 207, the operator will provide to a potential co-author an interest form wherein the interest form is configured to facilitate capture of a summary of a story of an experience of a co-author in which the co-author would potentially like to have published as a book. In step 209, the potential co-author is provided and executes review of the royalty agreement. It is intended within the scope of the present invention that a royalty agreement will be executed between the operator of the content creation and publishing method 100 and a co-author. The royalty agreement serves to identify the financial terms and conditions that will govern the relationship between the operator and co-author. By way of example but not limitation, exemplary conditions of the royalty agreement can include but are not limited to the following: co-author pays initial payment of five thousand dollars to operator in order to receive seventy five percent royalty of revenue from book sales, co-author pays initial payment of three thousand five hundred dollars to operator in exchange for fifty percent royalty of book sales and co-author pays an upfront payment of two thousand dollars to operator in exchange for twenty five percent share of book sales revenue. It should be understood within the scope of the present invention that numerous alternate terms of the royalty agreement could be provided.

In step 211, the co-author completes the interest form wherein completion thereof will provide a complete summary of at least one experience of the co-author. Step 213, the operator and the co-author will execute the royalty agreement through signing thereof. In step 215, the operator will review the content creation extrapolated from the interest form as discussed herein. Step 217, the co-author and/or the operator will provide final approval of the content in order for the content to be utilized to create a book. In step 219. The co-author will provide assistance to the operator in the marketing of the book. By way of example buy not limitation, the co-author will provide one hundred email addresses of potential buyers of the book to whom the operator can market the book thereto. Step 221, ensuing sales of the book and executed on a routine time interval, the operator will disperse royalties as agreed to in the royalty agreement to the co-author.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A book creation and publishing method that is configured to facilitate creation of a book from a story or experience from an individual wherein the method comprises the steps of:
organizing at least one seminar, wherein the at least one seminar is conducted at a multi-residential property;
conducting the at least one seminar, wherein an operator of the present invention conducts the at least on seminar, said at least one seminar providing educational content on the book creation and publishing method;
capturing attendee information, wherein the operator will capture demographic information about each attendee of the at least one seminar;
expressing an interest in book development, wherein an attendee provides notification of desire to become a co-author;
presenting a royalty agreement to the co-author, wherein the royalty agreement dictates financial terms between the operator and the co-author;
providing an overview form to the co-author, wherein the co-author utilizes the overview form to capture a summary of an idea to be utilized in creation of the book;
executing the royalty agreement, wherein the operator and the co-author execute the royalty agreement;
reviewing the overview form, wherein the operator will review the overview form;
executing word volume expansion of material provided in the overview form, wherein the operator employs a software configured to expand the word volume of the material to create an expanded content;
editing the expanded content, wherein the operator will edit the expanded content;
preparing the expanded content for publishing, wherein the operator prepares the expanded content for publishing thereof; and
publishing the book, wherein the book is published from the expanded content.

2. The book creation and publishing method that is configured to facilitate creation of the book from a story or experience from the individual as recited in claim 1, and further including a step of conducting a question and answer session, wherein the question and answer session is conducted at an end of the at least one seminar.

3. The book creation and publishing method that is configured to facilitate creation of the book from a story or experience from the individual as recited in claim 2, wherein the step of executing word volume expansion provides word quantity expansion of the material between and range of fifty to eighty percent.

4. The book creation and publishing method that is configured to facilitate creation of the book from a story or experience from the individual as recited in claim 3, and further including a step of designing a book cover, wherein the operator will facilitate graphical design of the book cover.

5. The book creation and publishing method that is configured to facilitate creation of the book from a story or experience from the individual as recited in claim 4, wherein the royalty agreement includes three tiers based on initial investment of the co-author.

6. The book creation and publishing method that is configured to facilitate creation of the book from a story or experience from the individual as recited in claim 5, and further including a step of collecting an initial investment from the co-author, wherein the operator collects an amount of money dictated by the royalty agreement.

7. The book creation and publishing method that is configured to facilitate creation of the book from a story or experience from the individual as recited in claim 6, and further including a step of transmitting the expanded content to a ghost writer, wherein the operator transmits the expanded content to a ghost writer for final development thereof.

8. The book creation and publishing method that is configured to facilitate creation of the book from a story or experience from the individual as recited in claim 7, and further including a step of editing the expanded content ensuing transmission thereof to the ghost writer, wherein the operator provides editing of the expanded content.

9. The book creation and publishing method that is configured to facilitate creation of the book from a story or experience from the individual as recited in claim 8, and further including a step of receiving approval from the co-author, wherein the co-author provides approval of the expanded content ensuing editing thereof.

10. The book creation and publishing method that is configured to facilitate creation of the book from a story or experience from the individual as recited in claim 9, and further including a step of providing typesetting of the expanded content, wherein the expanded content is prepared and formatted to be placed into the book.

11. The book creation and publishing method that is configured to facilitate creation of the book from a story or experience from the individual as recited in claim 10, and further including a step of uploading the book to an on-demand portal for publishing thereof.

12. The book creation and publishing method that is configured to facilitate creation of the book from a story or experience from the individual as recited in claim 11, wherein the co-author is at least over an age of fifty-five.

13. The book creation and publishing method that is configured to facilitate creation of the book from a story or experience from the individual as recited in claim 12, and further including a step of leveraging communication through a community group, wherein information about the at least one seminar is disseminated through the community group.

14. The book creation and publishing method that is configured to facilitate creation of the book from a story or experience from the individual as recited in claim 13, and further including a step of providing assistance in marketing of the book, wherein the co-author provides a multitude of email addresses to the operator.
